(19) United States
(12) Patent Application Publication
(10) Pub. No.: US 2007/0033108 A1
(43) Pub. Date: Feb. 8, 2007

(54) Systems and methods for tracking component-related information associated with buildings

(76) Inventor: Stanley R. Luhr, El Cajon, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/198,579

(22) Filed: Aug. 5, 2005

(51) Int. Cl. G06Q 20/00; G06G 1/14

(52) U.S. Cl. 705/22

(57) ABSTRACT

A system is described for collecting, maintaining, and using information about construction, maintenance, and use features of buildings and their components. One or more building identifier tags affixed to a building during construction include a unique building identifier for the building and access information allowing a user to access a computer-implemented repository of information about the building. The repository may comprise information about components in the building, which may be identified in the repository by product identifiers, as well as information about component manufacturers, warranties, installation and maintenance instructions, information about workers associated with construction of the building, and quality checkpoints useful for checking and documenting the quality of construction for the building. The repository may also facilitate registration of warranties, transmission of safety and recall information associated with building components, targeted marketing of offers to residents of the building, as well as other communications amongst parties associated with the building.

### FIELD OF THE INVENTION

The invention relates to computer-implemented data collection and storage systems, and in particular, data collection and storage systems for maintaining data about components of buildings.

### BACKGROUND OF THE INVENTION

Buildings, such as homes and other types of real property units, are complex systems comprising many separate and interacting components, including building materials, fixtures, appliances, and the like. Many of the components have associated installation and maintenance information, repair information, warranty information, and the like, that may be available to an installer, homeowner, occupant, or other interested party if the party knows how and where to find the information. Similarly, much construction-related information associated with a real property unit may be of value during its lifetime to the aforementioned parties as well as to a variety of other interested parties, such as insurance agents, real estate estimators, architects, city inspectors, and others, if the parties know how and where to access the information, and if, indeed, the desired information has been preserved.

Typically, however, much very useful information about a real property unit, and especially information that is generated during construction of the real property unit, is either not recognized as being of future value or is simply not preserved in a systematic, comprehensive, and logical manner.

For example, warranty information for components in a home or other building is typically not gathered and maintained in a manner that best serves the needs of the eventual owners of the building and the components. Many components of a new house are frequently covered by manufacturers' warranties, including kitchen appliances, heating/cooling systems, and bathroom fixtures. In addition to these visible components, other components, such as building materials, may also frequently be covered by warranties, unbeknownst to the ultimate homeowner or occupant. For example, packaging for vinyl siding or roofing materials or paint may contain warranty information that is thrown away without ever being brought to the homeowner's attention. Some warranties may be embedded in trade agreements with the builder of a home, such as a warranty on termite control work or on the workmanship of a roofer, and may not ever be given to a new home owner. Even when a home owner is left a folder or kitchen drawer full of warranty cards to fill out, the cards may sometimes require a serial number, model number, or other information from the component that is difficult or impossible to access once the component is installed.

Furthermore, registering a warranty does not spare the homeowner of subsequent confusion about the coverage. Expiration dates may be difficult to assess accurately because some products, like water heaters, have different warranty periods for different parts of the product. Many times it is difficult to know which component defects are covered by the builder and which are covered by the manufacturer, and for how long. Imprecise or out-of-date information provided to the manufacturer can complicate or nullify later coverage.

Warranties registered at the time of product purchase may incorrectly name a builder, contractor, or purchaser of a gift as the warrantee rather than the ultimate homeowner, and warrantee information is rarely updated upon sale or re-sale of a home. Warranty registration systems that register warranties at the time of product purchase or at the time of assumption of home ownership cannot typically provide installation date information that is frequently critical to warranty coverage, nor do they provide any mechanism for verifying, when required, that the component was installed by a certified or licensed installer.

With all of these difficulties, only about 2% of available warranties are typically registered with the manufacturer. Thus, manufacturers rarely know where, with whom, and by whom their products are installed. Manufacturers thereby lose the benefit of this valuable information for marketing and research purposes, as well as for accurately and efficiently providing homeowners with important safety alerts and recalls, maintenance information updates, and the like. Without accurate information about when and where their components are being installed, manufacturers also lose the opportunity to provide installers and users with updated or customized installation, maintenance, or use instructions that may take into account building type, geographical location, product compatibilities, or other such specialized considerations.

Currently available warranty registration systems typically rely on registrations at a point of sale or by an eventual home occupant. Such systems also typically use a street address to identify a component location, even though reliance on street addresses is known to be mistake-prone, at least in part because of misspellings and/or confusion between names like 2^{nd} Street and 2^{nd} Avenue or between Grand Avenue N. and N. Grand Avenue. Furthermore, street names are occasionally changed over time, and accurate street names may not even be assigned at the time a component is purchased for a home in a new development. Currently available product information dissemination systems typically rely on a generic website format that does not provide for an interactive exchange of information between manufacturers and the eventual owners, users, installers, and repairmen of their products.

Systems are frequently even less well-developed for the gathering, maintaining, and disseminating of installation and care information for components of real property units.

### SUMMARY OF THE INVENTION

The present invention addresses these and other problems by providing a computer-based system for collecting, maintaining, and using information about buildings and their components, including, among others, construction, installation, maintenance, and use information. The computer-based system digitally links the physical address of an installed component to its manufacturer. One or more building identifier tags affixed to a building during construction include a unique building identifier for the building as well as access information allowing a user to access a computer-implemented repository of information about the building. The repository uses product identifier codes associated with components installed in the building to store information associated with the installed component The repository may comprise, among other types of information, information about components installed during construction of the building and their manufacturers, information about warranties associated with the components, information about the care and use of components in the building, information about workers who worked on the construction of the building, and/or information about quality checkpoints useful for checking and documenting the quality of construction of the building during construction. The repository may also facilitate registration of warranties and transmission of safety and recall information associated with building components, as well as targeted marketing of offers to residents of the building.

An embodiment of a computer-based communications system is described, wherein the system allows manufacturers of building components to identify and communicate with users associated with the building components. The communications system comprises: a product identifier code associated with a building component and affixed in a readable form to the building component or to the building component's packaging, a tag that is affixed to a real property unit at which the building component is or will be installed and that includes a unit identifier code that uniquely identifies the real property unit, and a computing system. The computing system is electronically accessible to a manufacturer of the building component and is configured to: receive an electronic notification that the building component associated with the product identifier code is or will be installed at the real property unit associated with the unit identifier code; electronically identify the manufacturer associated with the building component based on the product identifier code; transmit an electronic notification of the installation at the real property unit to the manufacturer; and provide the manufacturer with contact information that allows the manufacturer to transmit information to a user associated with the real property unit.

An embodiment of a system for collecting and maintaining information about components in a real property unit is described. The system comprises: a unit identifier tag that comprises a machine-readable and/or visually defined unit identifier code and that is affixed to a real property unit for uniquely identifying the real property unit, a product identifier code that identifies a component in the real property unit and that is affixed to the component or to packaging associated with the component, an input device for electronically obtaining the unit identifier from the unit identifier tag and the product identifier, and a software component. The software component is configured to receive the unit identifier code and the product identifier code from the input device and to store the unit identifier code and the product identifier code in a database record associated with the real property unit. The software component may be further configured to use the product identifier code to identify a manufacturer of the component and to communicate with the manufacturer.

An embodiment of a computer-implemented method for electronically registering a warranty for a building component used in the construction of a real property unit is described. The computer-implemented method comprises a step that includes receiving, at a computing system, information from an electronic device used during construction of a real property unit, wherein the information includes at least a unique unit identifier for the real property unit and a product identifier for a building component used in the construction of the real property unit. The computer-implemented method further comprises additional steps that include: using the product identifier to identify a manufacturer who manufactured the building component, establishing a computer-implemented contact with the identified manufacturer and providing information about the building component and about the real property unit in order to register a warranty for the building component, receiving a confirmation of the component's warranty registration, and storing a record of the warranty registration in the computing system.

An embodiment of a computer-implemented method for electronically providing current installation instructions for a building component used in the construction of a real property unit is described. The computer-implemented method comprises the steps of: receiving, at a computing system, information from an electronic device used during construction of a real property unit, wherein the information includes at least a unique unit identifier for the real property unit and a product identifier for a building component used in the construction of the real property unit; using the product identifier to identify a manufacturer who manufactured the building component; and establishing a computer-implemented communication with the identified manufacturer and providing information about the building component and about the real property unit in order to receive installation instructions for the building component.

An embodiment of a system for collecting, maintaining, and using information about construction, maintenance, and use features of buildings and their components is described. The system comprises one or more building identifier tags, a computer-implemented repository of information about the buildings, a first input device, and a building information access device. The one or more building identifier tags are affixed to buildings during construction of the buildings, and the one or more building identifier tags for each building including a unique building identifier for the building. The computer-implemented repository of information about the buildings comprises records associated with individual buildings. A record for a building includes the unique building identifier for the building and at least one of: information about components installed during construction of the building, information about manufacturers who manufacture the components installed in the building, information about warranties associated with the components, information about the care and use of components in the building, information about workers who worked on the construction of the building, and information about quality checkpoints useful for checking and documenting the quality of construction of the building during construction. The first input device is configured to electronically receive the unique building identifier and to send the unique building identifier to the computer-implemented repository of information. The building information access device is configured to electronically receive a request to access the computer-implemented repository of information. The building information access device is further configured to electronically receive a password and the unique building identifier for the building, and, if the password is valid, to use the unique building identifier to provide access to at least a portion of the records associated with the unique building identifier.

Neither this summary nor the following detailed description defines or limits the invention. The invention is defined by the claims.

### BRIEF DESCRIPTION OF THE DRAWINGS

A general architecture that implements various features of specific embodiments of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIG. 1 is a block diagram that provides a broad overview of one embodiment of a system for collecting, maintaining, and using information about construction, maintenance, and use features of real property units and their components.

FIG. 2 is a block diagram that provides a more detailed view of one embodiment of a central database system for use with the building information system depicted in FIG. 1.

FIGS. 3A and 3B depict two examples of building identifier tags.

FIG. 4A depicts one example of a web page for allowing users to interface with the central database system.

FIG. 4B depicts an example of a web page that allows a new home owner to register with the central database system.

FIG. 5 depicts one embodiment of a process for collecting, maintaining, and using information about construction, maintenance, and use features of real property units and their components.

FIG. 6 depicts one embodiment of a process for electronically registering a warranty for a building component used in the construction of a real property unit.

FIG. 7 depicts one embodiment of a process for electronically providing current installation instructions for a building component used in the construction of a real property unit.

### DETAILED DESCRIPTION OF THE PREFERRED EMBODIMENTS

Embodiments of systems and methods are described for collecting, maintaining, and using information about construction, maintenance, and use features of real property units and their components. In particular, a central database system, accessible to builders, owners, occupants, tradesmen, inspectors, manufacturers and other authorized parties of interest receives, maintains and provides information about real property units and their components.

Although the systems and methods have mainly been described for purposes of this disclosure as pertaining to homes, such as single-family detached residences, the systems and methods may pertain, in a variety of embodiments, to additional or alternative types of real property units. For example, in various embodiments, the central database system may receive, maintain, and provide information about duplexes and other multi-unit buildings, townhouses and other attached units, condominiums, apartments, as well as other types of buildings, such as offices and other commercial units, or even mobile home units.

Furthermore, the systems and methods have been described with reference to the figures to follow as receiving, storing, maintaining, and providing information about a variety of different “building components” or “products,” such as installed appliances, building materials, building systems, and other pre-manufactured components that are installed and/or otherwise used in a home. As will be described in greater detail, the information about the components may comprise, among other types of information, installation, use, and maintenance information, warranty information, product compatibility information, and the like. However, in a variety of embodiments, the systems and methods may also store warranty-related and other associated information for services that have been performed at the home, such as warranty information for pest control work, chimney maintenance, and the like, done at the home.

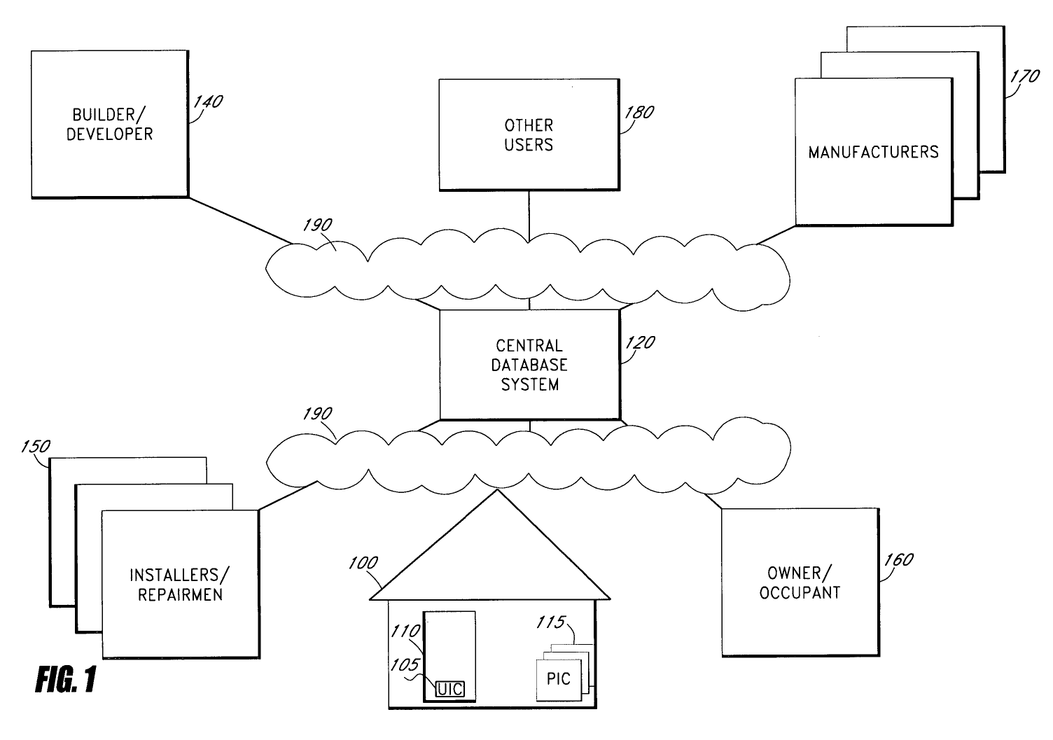

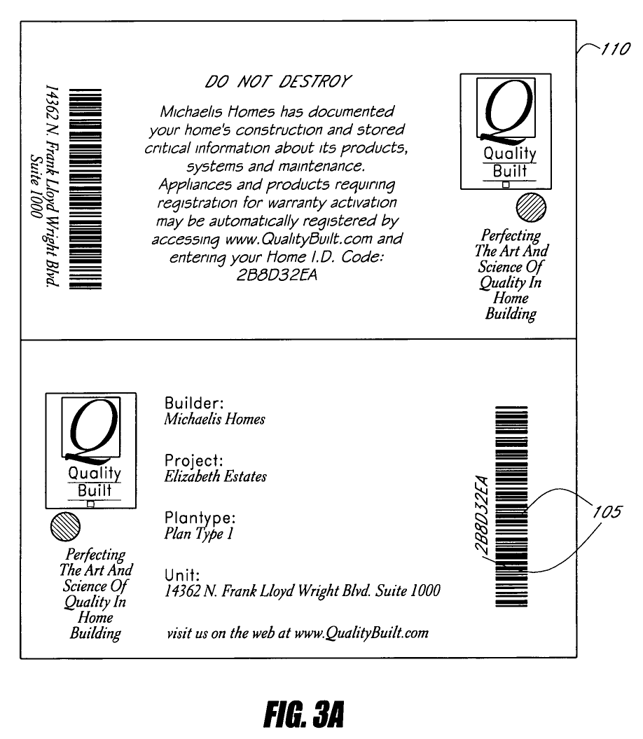

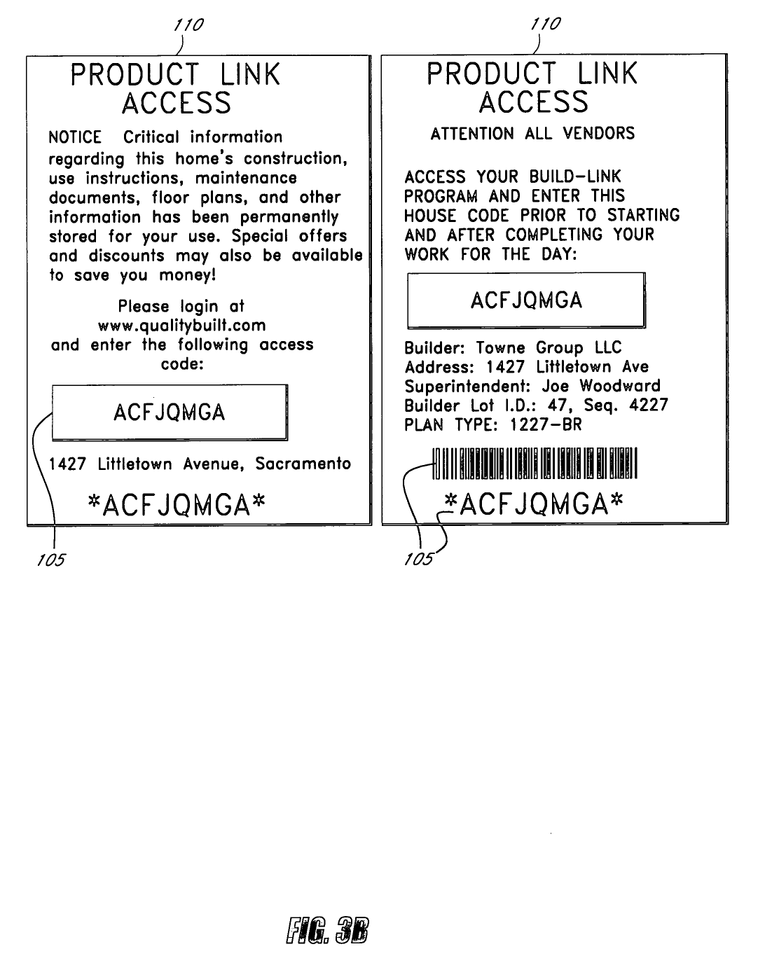

FIG. 1 is a block diagram that provides a broad overview of one embodiment of system for collecting, maintaining, and using information about construction, maintenance, and use features of real property units and their components. As depicted in FIG. 1, a home 100 is associated with unit identifier code (UIC) 105 that may be encoded onto one or more home identifier tags 110 which are affixed to the home 100. The UIC 105 uniquely identifies the home 100 and allows a variety of types of information about the home 100 to be easily stored and logically accessed in a central database system 120. A preferred embodiment includes a set of plastic cards that are affixed to the home 100, for example to its foundation, at the beginning of construction. The home identifier tags 110 may include weatherproof bar codes, RFID devices, or other machine-readable or other systems of identification that allow the home 100 to be uniquely identified and in turn allow access to electronically stored data about the home 100, as will be described in greater detail in the disclosure that follows. As construction of the home 100 progresses, additional home identifier tags 110 may be placed in other locations in the home 100, such as in an electric meter or sub panel, at a front entry foundation, in a basement, attic and garage and other areas as needed. Embodiments of the home identifier tag 110 will be described in greater detail with reference to FIGS. 3A and 3B.

As further depicted in FIG. 1, the home 100 includes one or more products or components with associated product identifier codes (PICs) 115, which may be affixed to or encoded on the product and/or,the packaging of the products in a machine-readable or other form. Examples of products that may have product identifier codes 115 include, but are not limited to: appliances such as a dishwasher, garbage disposal, garage door opener, hot water system, thermostat system and the like; building components such as pipes, paint, roofing materials, windows and the like; and other installed components, such as lighting and plumbing fixtures, flooring and window treatment materials, and hardware for doors, cabinets, and closets. The PIC 115 may be used to identify the product type and the manufacturer 170 of the product. The PIC 115 may be further used to uniquely identify the individual unit of the product that is being installed in the home 100.

Information about components in a home 100 may be stored in a central database system 120 or other type of computer-based system using the PIC 115 for a component together with the UIC 105 for the home 100 as indices. Furthermore, other construction-related and other information about the home 100 may be stored in the central database system 120 in a form that is retrievable as a collective record of information about the home 100.

Although the central database system 120 of the embodiment depicted in FIG. 1 resides in a single location, in other embodiments, the central database system 120 may be implemented as a distributed system of hardware, software, and related components that function together across a variety of physical and/or geographical locations. Thus, the term “central” does not imply that all of the computers of the system 120 reside in a common location; rather, the term is used to imply that these computers operate collectively as the main source of information about the associated real property units 100 and their components.

Several types of entities may use the UIC 105 and/or the PIC 115 in conjunction with a computer-based communications system to send and receive information about the home 100 and/or about components in the home to and from the central database system 120. Such entities include, but are not limited to: homeowners and/or occupants of the home 160; tradesmen, installers, repairmen, other construction workers, and/or inspectors 150; builders and/or building project developers 140; manufacturers 170 of the products and components used in the home 100; and other authorized parties 180.

The entities 140, 150, 160, 170, 180 that use the central database system 120 typically communicate with the central database system 120 electronically, using a computer-based network 190 or other communications system, including, but not limited to, the Internet. The entities 140, 150, 160, 170, 180 may use any of a wide variety of computers or other electronic devices and any of a wide variety of communications techniques to access the central database system 120. For example, the builder or developer 140 of a home 100 or housing development may initiate creation of a record for the home 100 in the central database system 120, using a personal computer (PC) or other commonly available computer device. On the job site, a construction worker 150, inspector, or supervisor may use any of a wide variety of wireless communications devices, such as personal digital assistants (PDAs), laptop or notebook computers, web-enabled cell phone devices, or the like to communicate with the central database system 120. Alternatively, a computer device capable of communicating with the network 190, which has been ruggedized for use at a construction site, may be installed, semi-permanently at the job site for use in communications with the central database system 120 during construction of the home 100. In other embodiments, information may be entered into an electronic device at the job site but may not be immediately transmitted to the central database system 120 from the job site. Instead, the information may be transmitter later, such as when an installer 150 with an electronic scanning device scans a home's UIC 105 and a component's PIC 115 at the jobsite and later uploads the scanned information onto a PC at another location for transmission to the central database system 120. An owner or occupant 160 of the home 100 may similarly use any of the above-described devices, or others, to communicate with the central database system 120. In some embodiments, a single computing device may be used to input both the UIC 105 and the PIC 115; in other embodiments, different computing devices may be used to input the UIC 105 and the PIC 115 separately.

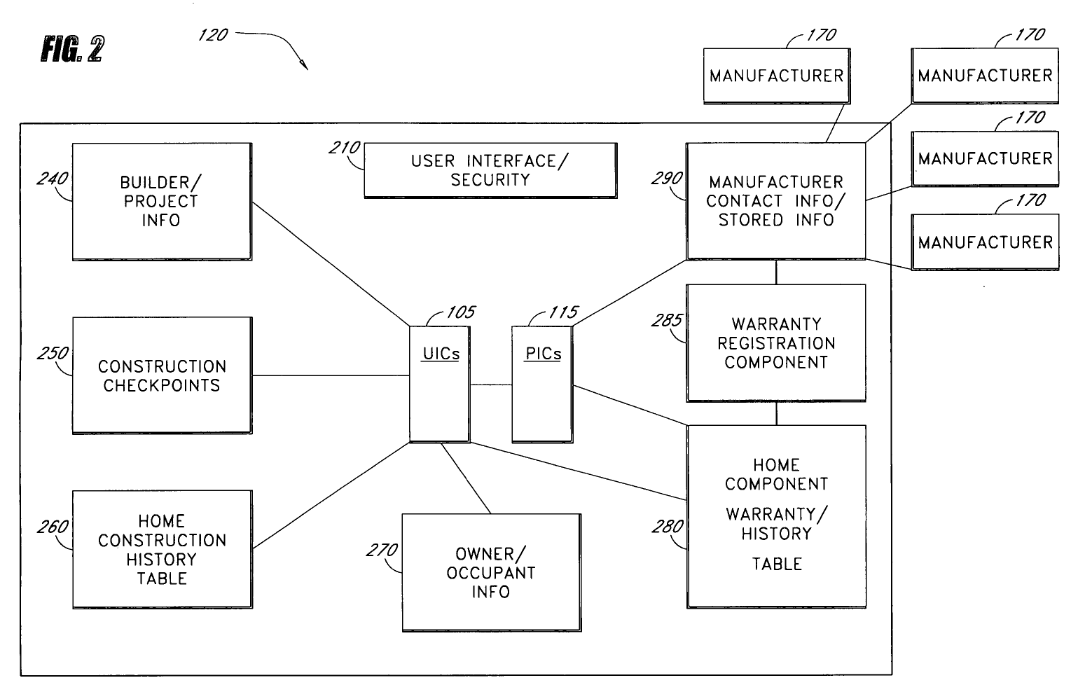

In a preferred embodiment, an interface, such as a web site, for example, is provided through which users 140, 150, 160, 170, 180 may access the central database system 120. In addition to providing the UIC 105 for the desired home 100, users may be required to log in to the central database system 120 using a pre-assigned passcode that may identify the type of user requesting access. A next web page for interacting further with the information in the central database system 120 may be presented to the user based on the identified user type. The types of information about a home 100 that are accessible to a given user, and the types of information-access operations that can be performed (e.g., view, modify, delete, etc.), may be dependent upon the access rights or privilege level of that user (e.g., owner 160, developer 140, manufacturer 170, installer 150, etc.), as will be described in greater detail with reference to FIG. 2. Furthermore, the central database system 120 may implement an access control scheme to provide this functionality. In other embodiments, access may be controlled according to another scheme, or may be provided on an uncontrolled basis to users, who may or may not need to provide a passcode that identifies their type or privilege level.

The UIC 105 for the home 100 may be assigned by the central database system 120 at the request of the builder 140, preferably early in the design phase of the home 100. Information related to that home 100 may thus be collected and stored for the life of the home. The builder 140 may be prompted to enter any of a wide variety of types of information associated with the home 100 and, if applicable, with an overall development project of which the home 100 is a part. For example, the builder 140 may enter information about the home's 100 legal description, anticipated street address, anticipated construction schedule, size, number of stories, anticipated product and component list, including specific amenities such as fireplace, granite counters, paint selection by room, floor coverings, roofing material and type, and planned installation of various components such as rain gutters, swimming pools, filtration devices. The builder 140 may also enter information that may apply to some or all of the other homes in a development, such as builder name and contact information, geographic, climatic and geologic zones, links to blueprints and floor plans, links to relevant building and civil codes, anticipated construction schedule, job crew information, housing development information, and the like.

The central database system 120, together with the home's UIC 105 and the PICs 115 of products in the home 100, may be further updated and used in a variety of ways by a variety of tradesmen 150, including installers, inspectors, and later repairmen or other maintenance personnel. For example, a workman 150 hired to install an appliance or other product may use an electronic device to scan, electronically read, or otherwise capture the home's UIC 105 and the appliance's PIC 115 for transmission to the central database system 120. In response, the central database system 120 may access up-to-date installation information from the manufacturer 170 that is stored by central database system 120 or that is accessed from the manufacturer 170 via computer network connection 190 on an as-needed basis.

Although for purposes of this disclosure, a manufacturer 170 is described as providing installation and other product-related information, as will be described in greater detail throughout this disclosure, it should be understood that another party, including, but not limited to, a representative or agent of the manufacturer 170, may fulfill the functions described herein as being performed by the manufacturer 170. For example, another party may perform functions related to warranty management, customer service, safety regulation compliance, replacement parts management, and marketing and promotion, either on behalf of the manufacturer 170 or not. The use of the term “manufacturer” throughout this disclosure is to be understood to refer to a manufacturer 170 or to another party who fulfills the functions described herein as being carried out by the manufacturer 170.

When the manufacturer 170 wishes to make available installation and/or maintenance instructions for a component that are customized based on the home's 100 geographic location, climate zone, construction type, and/or other components used, the central database system 120 preferably uses the UIC 105 and the PIC 115 to access stored information about the home 100 so that an installer 150 may be provided with appropriate customized installation instructions for use at the job site. Such customized installation instructions may, for example, include specialized instructions for the home's local weather conditions or soil type or provide information about compatibility with other materials and products listed in the central database system 120 as being used in the home 100.

In additional to installation instructions, a manufacturer 170 may wish to provide an installer or other tradesman 150 with access to a material safety data sheet (MSDS) that is mandated by the federal Occupational Safety and Health Administration (OSHA) to be included with many products. Typically, even when the original MSDS is outdated or lost, the manufacturer 170 is still responsible for providing the safety information. The use of updated and downloadable MSDS safety sheets, along with warnings for specific interdictions, can help reduce jobsite injuries and improve product use.

For many warranted products and construction components, warranty coverage begins at the time of installation. Thus, preferably, the central database system 120 is programmed, for at least some types of components, to initiate an automatic warranty registration process with the associated manufacturer 170 at the time of installation. If desired, the central database system 120 may prompt the installer 150 to provide information useful for warranty registration. This provides a great improvement over warranty registration systems that require the eventual homeowner to enter information that may no longer be remembered or physically accessible. Furthermore, for warranties that are contingent on installation by a certified installer, or that provide incentives for installation by a certified installer, the installer 150 may advantageously be prompted to provide certification information. Additionally, upon successful completion of the installation, photographic or other documenting data, such as initial operating temperatures or pressures, may be input by the tradesman 150 and stored by the central database system 120.

In some embodiments where the tradesman 150 or builder 140 provides a warranty to the owner 160 (in addition to or as an alternative to the manufacturer 170), the warranty information may be input to the central database system 120 by the builder 140 or tradesman 150. For example, an agreement may be included to fix drywall cracks one time during the first year, to repair sticking doors the first year, to unclog any sewer pipe for the first ninety days, or offering a structural warranty for ten years. For some development projects, the same or similar warranties may be offered for all homes 100 in the project, and they may therefore be noted in association with the UICs 105 of all included homes 100.

The central database system 120 may provide access to a repository of information about warranties of the products in a home 100, including, for example, information about the duration, coverage, and conditions of the warranties. The central database system 120 may store some or all or none of the warranty information internally and may provide access links to some, all, or none of the information that is stored externally to the central database system 120, such as information that is maintained on a computer website by a manufacturer 170.

In some embodiments, the tradesman 150 and the builder 140 may use the central database system 120 for communications with each other about the home 100. For example, the central database system 120 may also provide clock-in/clock-out services for tradesmen 150 working on construction of the home 100 so that a builder 140 in charge of overall construction of a home or housing development may be able to track the presence and progress of work crews at a job site. The builder 140 may use the central database system 120 to identify workers working on the home, request input of license number or otherwise verify the worker's qualifications, and, in some embodiments, to record that specific installation instructions have been fulfilled. For example, the central database system 120 may be able to receive and store electronic photographs that have been taken at the building site to document building progress and/or to document proper installation of building components.

Furthermore, the central database system 120 may allow an inspector 150, coming later to check the quality of a product's installation, to access customized checkpoint guidelines to insure correct installation.

Additionally, the central database system 120 may keep a date-stamped or other log of installation, maintenance and repair events associated with a given product or component in the home 100. Currently, this important information is rarely available to subsequent repairmen, and it is unlikely to be remembered or even properly documented over the years of a product's lifetime in a home 100. Records of a product's maintenance history or feedback from installers 150 in the field are even less likely to be currently available to the product's manufacturer 170, although such information would be very useful for a variety of marketing, monitoring, and product development purposes.

The central database system 120 may provide an owner and/or an occupant 160 of the home 100 with access to information about the home 100 and the components in the home, as has been discussed above. The UIC 105 may be given to new owners 160 once they are identified as such, allowing the owners 160 privileges and access to the central database system 120. The central database system 120 may also provide owners 160 with certain information such as current percentage of construction completed, site progress inspection photos, floor plans and other house data so the owner 160 can benefit and utilize these components in preparation for home ownership, including, for example, planning for furniture purchases, and the like.

Using the central database system 120, the owner 160 may view legal documents, disclosures, warranties, product information, paint and floor covering selections, and the like, that are stored in the central database system 120 in association with the owner's 160 home 100. Owners may forward pertinent documents to banks, appraisers, home inspectors, and the like, for their use during home construction or maintenance. Owners 160 may update information associated with their home when remodeling or new products are installed. Owners 160 may update data stored about the products in their home when routine, scheduled or unscheduled maintenance and repair is made. Owners may access stored information about qualified maintenance and/or repair persons for the components in their home 100. Owners 160 may further create and update a home inventory file to identify their personal belongings room by room for insurance purposes, or transfer their personal home inventory to a new physical property location.

The central database system 120 may differentiate between the information that it provides to owners and the information that it provides to home occupants. For example, if an occupant is renting the home 100, the occupant may be offered a more restricted set of information as compared to the owner, such as only a specified set of maintenance information and/or recall or use alerts and/or other specified information.

The central database system 120 may also provide an opportunity for manufacturers 170 to communicate with the owner and/or occupant 160 of the home 100. For example, a manufacturer 170 who wishes to issue a safety alert, product recall, or updated usage instructions may communicate with the owner and/or occupant 160 using access information received from the central database system 120. Similarly, the manufacturers 170 and/or other authorized third party entities 180 may wish to identify owners and/or occupants 160 whose homes 100 are known to include an identified product or component and to offer them promotional opportunities regarding upgrading, servicing, replacing, or purchasing additional accessories for the identified product or component. For example, the owner 160 may receive from manufacturers 170 and/or other third party vendors 180 special offerings, online coupons, or the ability to automatically order replacement parts such as furnace filters, water filters or paint that is specifically identified for their home 100.

The central database system 120 may include communications services, such as an email-type service, for the owners/occupants 160 or other users 140, 150, 170, 180 of the central database system 120. Alternatively or additionally, the central database system 120 may store and provide access to communication preferences information supplied by the owners/occupants 160. Such communication preferences may includes email addresses, mailing addresses, telephone numbers, and/or fax numbers, as well as any limitations imposed on their use, such as access only to certain types of entities or only for certain types of uses or only for certain hours of the day. Using the communications options provided by the central database system 120, owners and/or occupants may order from the builder 140 optional items for inclusion with construction of their home 100, if within prescribed schedule and deadlines. Owners/occupants 160 may further be afforded an opportunity to automatically communicate their acceptance of offers from third party vendors once payment information is stored.

In addition to the users 140, 150, 160, 170 of the central database system 120 that have already been described, a variety of other entities 180 may be authorized to access and use at least a portion of the information and services offered the central database system 120. For example, a vendor may use the central database system 120 to identify prospects for its products and/or services and may offer the products and/or services to the owners 160 in a customized and targeted format. For example, a fireplace chimney cleaner may target only those homes 100 that have wood burning fireplaces and that are more than three years old. Providers of pool cleaning or granite counter maintenance may identify and make offers to owners 160 of those homes 100 having such components. A plumbing contractor may target homes where his company performed the original work, pointing out that replacement parts for their particular fixtures are in stock and available.

Some entities may add information to the central database system 120. For example, a home inspection entity may access the central database system 120 the site to input information about significant defects discovered in the home 100, posting the findings to the appropriate UIC 105, and links the associated report to the home 100, offering the report for sale to subsequent users

In addition to entities wishing to make targeted marketing offers, other authorized parties 180 may wish to make use of information that is organized in an easily accessible format by the central database system 120. For example, a real estate appraiser may download the original unit floor plan and compare it with the square footage measured at the site to determine if remodeling was performed, and may access information about other relevant features of the home. An insurer who supplies risk coverage for the builder may wish to assess certain risk profile information related to its policy. A potential purchaser of the home 100 may be given the UIC and authorization to access the central database system 120 to determine the level of documented maintenance to the home. A builder or developer may access the history of maintenance performed on the property and thereafter alert the owner when prescribed maintenance has fallen below acceptable warrantable levels. A repair person who has received a customer service request to repair or perform maintenance on a component in the home 100 may access records that provide exact model information, past maintenance history, or other related information useful to have before and/or during the service visit.

A wide variety of uses and features have been described with reference to FIG. 1 for the systems and methods for collecting, maintaining, and using information about construction, maintenance, and use features of real property units and their components. However, the system configuration that is depicted in FIG. 1 is provided to exemplify and aid in explanation, and not to limit understanding of the scope of the systems and methods. Other types of entities may participate in the communications and information exchange described using the UIC 110 and/or PICs 115 as mediated by the central database system 120. For example, a homeowners' association or property management group may use the central database system 120 to fulfill its functions and/or to communicate with its members.

FIG. 2 is a block diagram that provides a more detailed view of one embodiment of the central database system 120 for use with the building information system depicted in FIG. 1. As depicted in FIG. 2, users access the central database system 120 through a user interface 210 module. In a preferred embodiment, the information in the central database system 120 is organized as a relational database that comprises a plurality of inter-linked virtual tables, or relations, which are indexed by the UICs 105 of the homes 100 and/or by the PICs 115 of the homes' components. Information about a given home 100 or other real property unit may be extracted from the tables of the central database system 120 based on the associated UIC 105 assigned to the home 100. The information stored in the central database system 120 may also be organized according to another structural system for information storage and retrieval. Furthermore, the central database system 120 may be implemented as a centralized system of hardware, software, and related components that function together in one physical location or the central database system 120 may be implemented as a distributed system of hardware, software, and related components that function together across a variety of physical locations.

The central database system 120 may provide security protocols, such as one or more password systems, that allow access to information stored in the central database system 120 only to authorized users. For example, homeowners may not want details about security systems installed in their homes to be available to all users who have access to the central database system 120 and/or they may not want to allow unrestricted access to their contact information that may be stored in the central database system 120. In some embodiments, different users may be granted different levels of viewing and/or editing privileges with regard to the information. Portions of the stored information may be accessible to a given user, while other portions are not.

For example, since building components are often shipped for use by either homeowners/occupants 160 and other consumers or by installing contractors 150, who are likely of very different skill levels with respect to installation of the component, manufacturers 170 are sometimes reluctant to provide advanced instructions for installing, servicing or troubleshooting a component in the normally packaged component instructions. Many manufacturers 170 would prefer having the ability to limit the specific installation instructions, or alter them depending upon whether the product is being professionally installed or installed by a non-professional. By using a field wireless computer, an installer 150 may scan the PIC 115 to instantly register the component with the central database system 120 and with the manufacturer 170 as being installed at the location associated with the home's UIC 105, while simultaneously receiving updated instructions or checklists for installation by the manufacturer. Specific “vendor only” data may be transmitted directly to the installer 170 without fear of such information being discovered or misinterpreted by an unqualified end user.

Furthermore, the central database system 120 may include, for example, owner/occupant information 270 that may list contact information and privacy preferences for the owners and/or occupants 160 associated with a given UIC 105, as well as associated dates of ownership and/or occupancy. In some embodiments, the contact information may include a telephone number, email address, or mailing address that may, if allowed by the owner and/or occupant 160, permit a manufacturer 170 or other interested party to contact the owner and/or occupant 160 directly with product safety alerts, recall notices, informational bulletins, and/or promotional offers. The owner/occupant information 270 may include one or more computer-accessible communications links for directly contacting the owner and/ or occupant 160. Additionally or alternatively, the central database system 120 may provide a contact intermediary system (not shown) for managing the passing of communications to and from various users. The contact intermediary system, may, depending upon its configuration, allow messages to be sent to an owner 160, for example, while protecting the owner's contact information from exposure to the public eye.

The central database system 120 may further comprise builder/project information 240 that includes information about a builder 140 of a home 100. When a home 100 is built as part of a multi-unit development, the builder/project information 240 may include other information that may be common and relevant to the houses or other real property units within the development. Information about expected overall project layout, expected street names, applicable local building laws and permits, blueprints, materials suppliers, subcontractors, building timelines, and geographical coordinates of the homes and any relevant soil or other geological information are examples of some types of information that may be stored with reference to the builder/project information 240. Information common to multiple homeowners within a particular development may include information about the common areas such as the clubhouse or pool rules, legal documents such as soils or noise abatement reports, etc. A builder should be able to post documents that apply to all his projects (such as how to contact customer service), a particular project (such as soil reports, engineering to the site), a particular plan type or building number (for specific floor plans and details), and a specific unit (such as contracts, correspondence, and/or owner-specific components.)

Construction checkpoints information 250 stored within the central database system 120 may include up-to-date information about proper installation of various building components for the home 100. Construction checkpoints information 250 may be provided to workmen 150 at the building site to instruct the workmen 150 as well as for quality control inspections of the home 100 during construction. In some embodiments, special conditions, such as geological or climatic conditions, or compatibilities between various building components, may be taken into account when providing instructions to the workmen 150. One suitable system for managing construction checkpoints is described in the Applicant's co-pending U.S. patent application Ser. No. 10/900,734, filed on Jul. 28, 2004, and entitled SYSTEMS AND METHODS FOR SELECTING AND PRIORITIZING CONSTRUCTION CHECKPOINTS, which is hereby incorporated herein by reference in its entirety. Thus, even before the home 100 is occupied and before any product warranties are registered, the central database system 120 may provide up-to-date information about components to be installed in the home 100 for use by installers and other construction workers 150.

The central database system 120 may further include a home construction history table 260 that maintains a log of information gathered during construction of the home 100. Information about installation dates, installation crews, and any unusual occurrences may be stored in the home construction history table 260.

The central database system 120 may additionally or alternatively include a home component warranty/history table 280 that lists components in a home 100, as indexed by the home's UIC 105 and the components PIC 115. The table 280 may include information such as installation date, installer name and certification, verification of proper installation procedure, warranty conditions and provisions, maintenance history, recommended service schedule, and the like.

Product data may further be included such that owners/occupants 160 can readily access maintenance schedules, instructions and warnings customized to the home's 100 features, as appropriate, from the manufacturer. Maintenance records may be collected to show that the owner 160 has provided necessary maintenance to maintain coverage of the various warranties and service agreements.

A warranty registration component 285 may automatically register the warranty for a component newly added to the central database system 120. The warranty registration component 285 may access relevant data stored in the central database system 120, such as stored owner/occupant information 270 and/or may prompt the owner 160 or installer 150 for additional information used for registering the warranty. The warranty registration component 285 may transmit the warranty registration information to the manufacturer 170 and may receive confirmation of the warranty's registration.

In FIG. 2, the warranty registration component 285 is depicted as residing within the central database system 120. As was noted with reference to FIG. 1, the central database system 120 may be distributed across multiple computing devices and across multiple physical locations. Furthermore, the warranty registration component 285 may operate as an external computing unit that can communicate with the central database system 120.

Additionally, the central database system 120 may include a table of manufacturer contact information and/or associated stored information 290. The information in the manufacturer table 290 allows the central database system 120 to communicate with manufacturers 170 of the components in the home 100 in order to receive up-to-date installation instructions, register warranties and provide component installation location information, and to receive safety alerts, promotional offers and the like for forwarding to home owners 160. In various embodiments, using the PICs 115 of the components, the central database system 120 may serve as a communications intermediary between manufacturers 170, builders 140, installers 150, and owners 160. The central database system 120 may alternatively or additionally provide contact information so that manufacturers 170, builders 140, installers 150, and owners 160 may communicate directly amongst themselves, based upon pre-determined security rules defined by owner(s) of the data.

The manufacturer table 290 may include information that correlates PICs 115 for various components with associated manufacturers 170 for the components. Information about the components may be accessed from the manufacturers 170 and transmitted to a requesting party on an as-needed basis and/or may be stored by the central database system 120 for distribution to users as desired.

In some embodiments of the central database system 120, maintenance schedules from each product manufacturer 170 are combined to form one logical maintenance schedule for the home 100, with options to allow owners/occupants 160 to accept maintenance tasks, delay them, schedule them with a vendor, or cancel them. Warnings may be established if critical maintenance is not performed, alerting users, third-party maintenance vendors or providers of replacement products, such as filters or rain gutter cleaning.

The embodiment of the central database system 120 depicted in FIG. 2 provides one example of a system for collecting, maintaining, using, and providing access to information about buildings and their components. In addition, upon reading this disclosure, other useful embodiments will be apparent to a practitioner of skill in the art.

FIGS. 3A and 3B depict two embodiments of building identifier tags 110 that may be affixed to a home 100. The building identifier tags 110 include the home's UIC 105, preferably in both machine-readable and human-readable formats. In the embodiment depicted in FIG. 3A, the UIC 105 is provided as a bar code, machine-readable by a bar code scanning device, and as a string of alpha-numeric characters that may be manually input into an electronic communications device and/or may be machine-read by a device with optical character recognition (OCR) capabilities.

During construction of the home 100, several building identifier tags 110 may be affixed to the home 100 in locations to provide access to the UIC 105 as needed by installers/inspectors/repairmen 150 and/or to owners and occupants 160. For example, a building identifier tag 110 as in FIG. 3A may be folded, sealed in a plastic casing for protection and attached to the foundation of the home 100 during early stages of construction. If desired, even before construction, a copy of the building identifier tag 110 may be affixed, for example to a stake in the ground, the site where the home 100 will be built. As construction of the home progresses, additional copies of the building identifier tag 110 may be placed so as to be more easily accessible when needed. For example, once an electrical service panel has been installed, a copy of the building identifier tag 110 may be affixed therein.

The building identifier tag 110 depicted in FIG. 3A further optionally includes the street address or legal description of the real property unit 100 and a suite number associated with the unit 100. Furthermore, the example building identifier tag 110 includes the World Wide Web address for the central database system 120 so that a user with appropriate verification may use a network-enabled device to enter the designated Web address and the UIC 105 in order to access the central database system 120.

In other embodiments, the building identifier tag 110 may be equipped with radio frequency identification (RFID) technology. Tags 110 with more passive forms of RFID may be read and used in much the same way that bar codes may be read and used, except that RFID tags are often able to store additional useful information beyond just the PID 115. Tags 110 with more active forms of RFID may “broadcast” their information to an RFID receiving device and may, in some embodiments, initiate communication with the central database system 120. In still other embodiments of a building identifier tag 110, other forms of information-transfer technology may be used to uniquely identify a home 100.

The product identifier codes (PICs) used to uniquely identify components used in the home may also be encoded using any of the technologies described above, including bar code technology, RFID technology, or other machine-readable and/or human-readable information transfer technology, and may be thus used to input and to access information about the home 100 and its components that is stored in the central database system 120.

FIG. 3B depicts a second embodiment of a building identifier tag 110 in which the UIC 105 is provided as a machine-readable bar code and as a string of alphanumeric characters and in which a Uniform Resource Locator (URL) address is provided for accessing the central database system 120 using the Internet or other computer network.

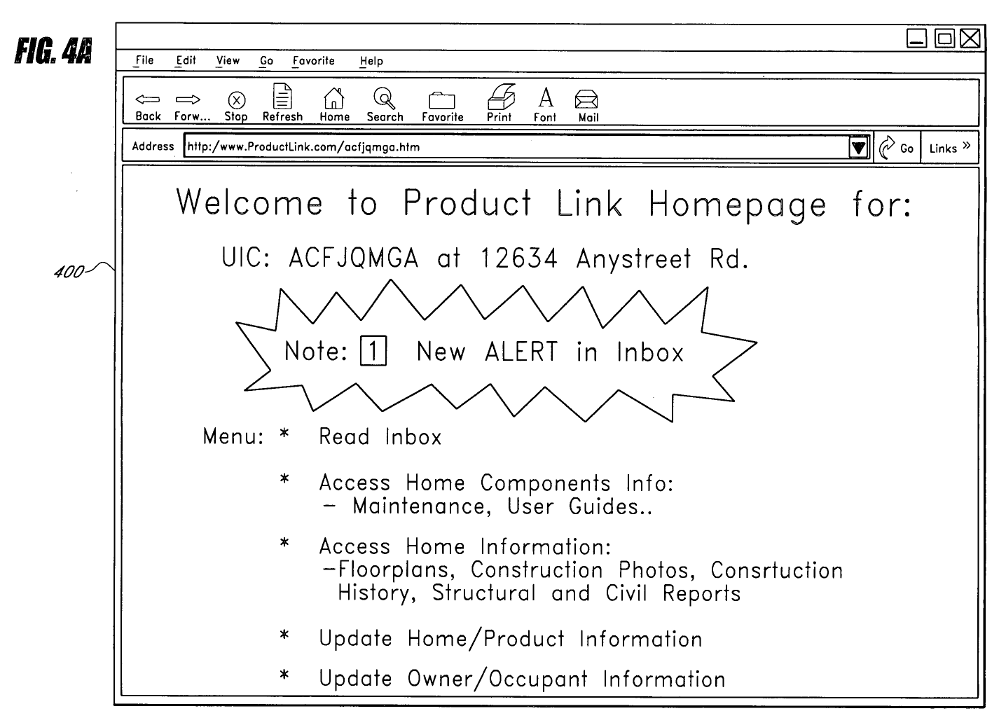

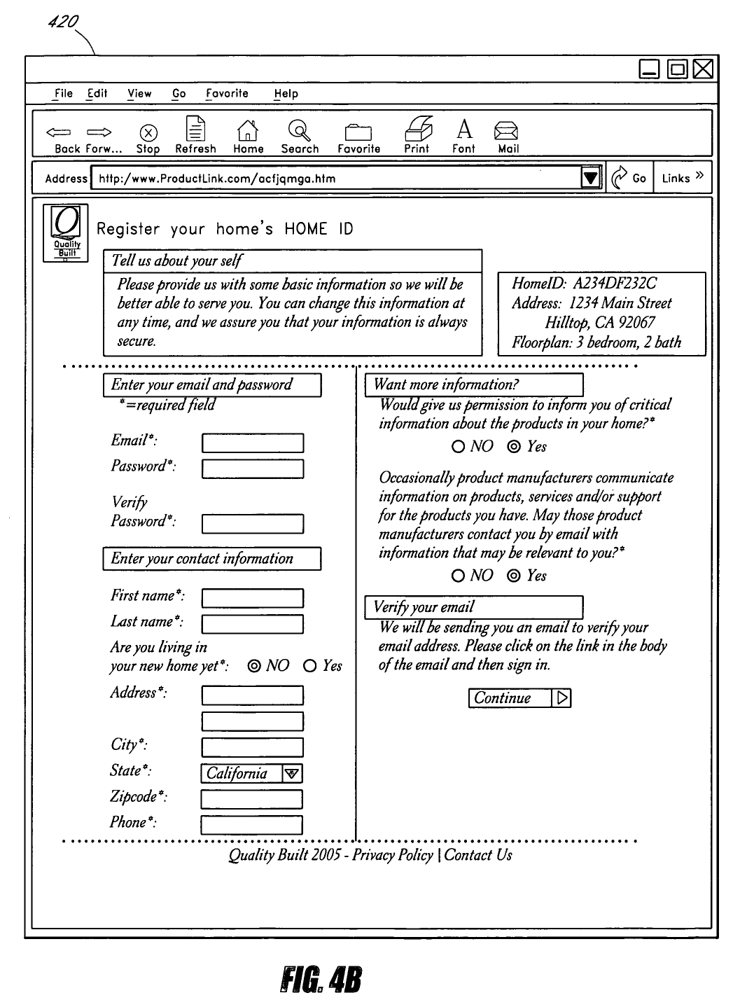

FIG. 4A depicts one embodiment of a web page 400 for allowing users to interface with the central database system 120. The sample web page 400 shown is a home page for a given UIC 105 and thus allows an authorized user who has entered the home's UIC 105 and, in some embodiments, a security password, to access information about the home 100 and its components. In the sample web page 400, the user is offered a menu of five actions. The user may access a message Inbox that stores emails and other communications, typically for use by the owner 160 of the home 100. In this example, an alert notice is also posted above the menu, notifying the user that a new component-related alert has been sent to the Inbox. The menu further allows a user to access information about components in the home. This information may be accessed, among others, by a workman at the time of installation of the component, by an inspector wishing to inspect the quality of the installation, by an owner or occupant wishing to verify warranty and/or maintenance information, by a repairman wishing to repair the component, by an insurance broker or real estate agent wishing to assess the age and/or value of the components, or by other interested parties. The menu also allows a user to access information non-component related information about the home, including, for example, floor plans, construction photos, construction history information, and structural and/or civil reports related to the property, among others. In addition, the menu allows a user to update information stored in the central database system 120 about the home 100, the components, or the owner and/or occupant 160.

In other embodiments, the webpage 400 associated with a given UIC 105 may provide these or other menu choices to a user of the central database system 120. In addition, a variety of other web pages may provide users with opportunities to insert, delete, read, and use the information in the central database system 120.

FIG. 4B depicts an example of a web page 420 that allows a new home owner 160 to register with the central database system 120. The home owner 160 is requested to provide an email address and an access password. The home owner 160 also provides information about whether or not he or she lives in the home 100, and whether or not he or she agrees to be notified with critical information about products in the home and/or to receive communications from manufacturers 170. In web pages that may be associated by link with the web page 420 of FIG. 4B, the home owner 160 may access information related to progress of the home's construction, including viewing photos taken at the construction site, viewing the floor plan, viewing construction-related documents, and the like. Other web pages may allow the home owner 160 to access information about a home inventory of products, a home and/or component maintenance schedule, and a homeowner profile, as examples.

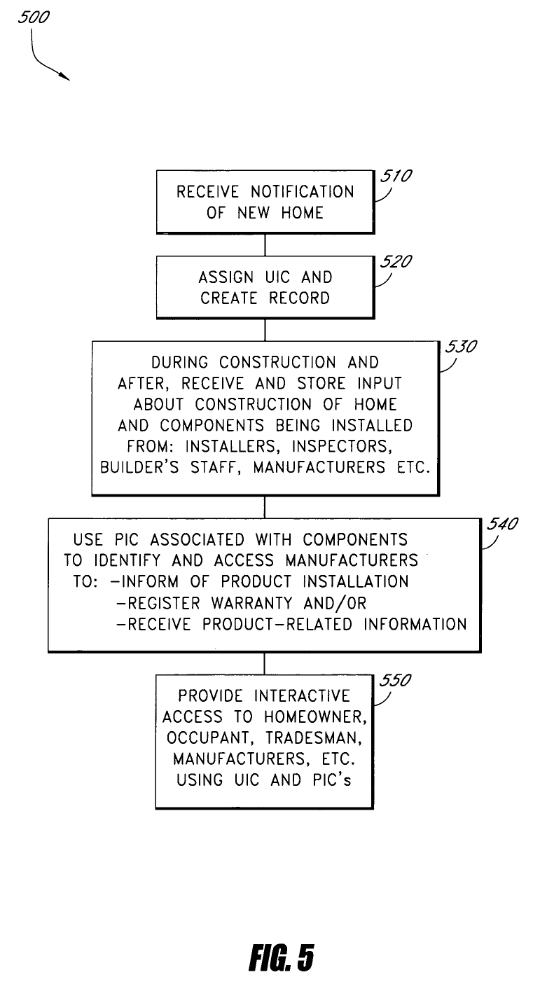

FIG. 5 depicts one embodiment of a computer-implemented process 500 for collecting, maintaining, and using information about construction, maintenance, and use features of real property units 100 and their components.

In block 510, the central database system 120 receives notification of a new home 100 or other real property unit for which records are to be kept in the central database system. This information is typically, but not always, received from the builder 140.

In block 520, a unique UIC 105 is assigned to the home 100 by the central database system 120. The builder 140 or other party may enter additional available information associated with the home 100, such as information about the builder and the development project 240 and information about the construction checkpoints 250, which may be available even before construction on the home 100 begins.

In block 530, during construction and after, the central database system 120 continues to receive and store input about construction of the home 100 and, using the PICs 115, about components being installed in the home.

In block 540, during construction and after, the central database system 120 uses the PICs 115 to identify manufacturers 170 associated with the components. The central database system 120 may contact the manufacturers 170, for example, to request installation information, to inform them that one of their components is being installed at the home 100 and that the owner and/or occupant of the home 100 may eventually be accessible using the central database system 120, and/or to register the component's warranty with the manufacturer 170. The database may alert the manufacturer of product interdictions with other products.

Product manufacturers may be provided specific information about the home 100, such as climate, type of installation, integrated components, anticipated use, and the like. Thus, the manufacturer 170 may be able to electronically deliver specific maintenance and use instructions for that specific installation that go beyond the normally available, generic instructions. In fact, the manufacturer 170 may create an electronic maintenance manual that is automatically customized to the home's 100 features, based on data collected about its components, geographic area, and the like.

In block 550, using the UICs 105 and the PICs 115, the central database system 120 provides interactive access, throughout construction and afterwards; to the information about the home 100 and the components in the home to a variety of users, including, but not limited to, owners, occupants, builders, tradesmen, inspectors, and manufacturers. As one example, a published construction schedule for the home 100 may include milestones that trigger transmission of an alert to the home owner 160 indicating an opportunity to make decisions on paint color, selection of finishes, options such as adding electrical outlets, speaker pre-wire, and the like.

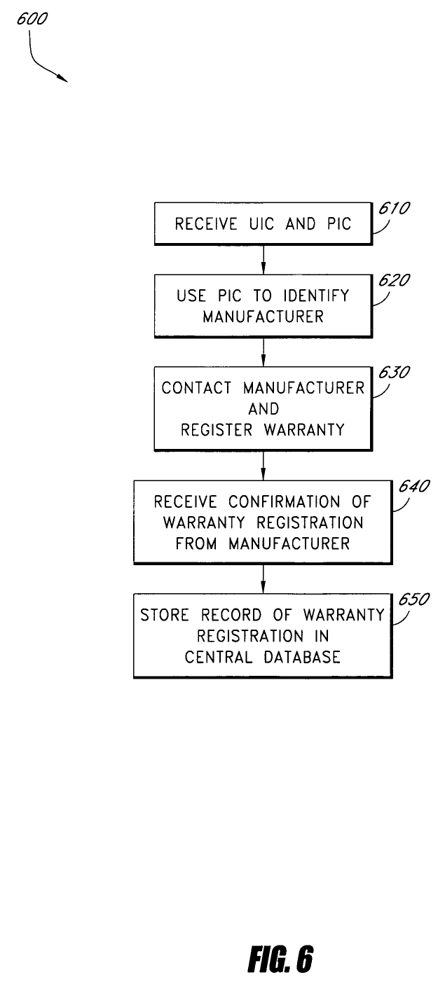

FIG. 6 depicts one embodiment of a process for electronically registering a warranty for a building component used in the construction of a real property unit. In block 610, the central database system 120 receives the UIC 105 and the PIC 115 for a component that is or will be installed in a home 100. In block 620, the central database system 120 uses the PIC 120 to identify the manufacturer 170 associated with the component. In block 630, the central database system 120 contacts the manufacturer 170 electronically and registers a warranty for the component. In block 640, the central database system 120 receives confirmation that the warranty has been registered, and in block 650, the central database system 120 stores a record of the warranty registration and, in some embodiments, of other information associated with the warranty.

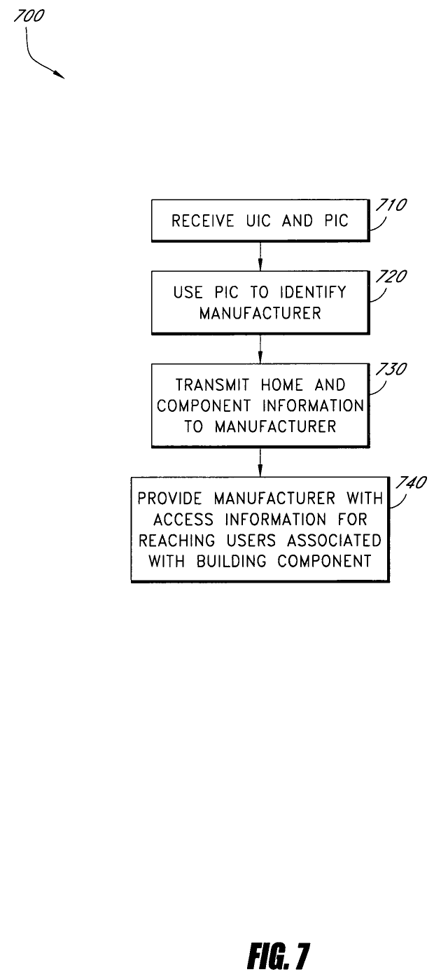

FIG. 7 depicts one embodiment of a process for electronically providing current installation instructions for a building component used in the construction of a real property unit. In block 710, the central database system 120 receives the UIC 105 and the PIC 115 for a component that is or will be installed in a home 100. In block 720, the central database system 120 uses the PIC 120 to identify the manufacturer 170 associated with the component. In block 730, the central database system 120 contacts the manufacturer 170 electronically and transmits information about the component and the home 100 to the manufacturer 170. In block 740, the central database system 120 provides the manufacturer 170 with access information for reaching users associated with the building component. For example, the central database system 120 may provide the manufacturer 170 with mailing, email, or telephone contact information for the owner/occupant, installer, and/or the developer so that the manufacturer 170 may contact some or all of these users directly. Alternatively, or additionally, the central database system 120 may provide communications services that allow the central database system 120 to serve as an intermediary between the manufacturer and other users 140, 150, 160, 180.

Although the foregoing systems and methods have been described in terms of certain preferred embodiments, other embodiments that are apparent to those of ordinary skill, including embodiments that do not provide all of the features and advantages set forth herein, are also within the scope of this invention. Indeed, the novel methods and systems described herein may be embodied in a variety of other forms. Accordingly, the accompanying claims and their equivalents are intended to cover such forms or modifications as would fall within the scope and spirit of the invention.

What is claimed is:

1. A computer-based communications system for allowing manufacturers of building components to identify and communicate with users associated with the building components, the communications system comprising:
a product identifier code associated with a building component and affixed in a readable form to the building component or to the building component's packaging;
a tag affixed to a real property unit at which the building component is or will be installed, wherein the tag includes a unit identifier code that uniquely identifies the real property unit; and
a computing system, electronically accessible to a manufacturer of the building component, wherein the computing system is configured to:
receive an electronic notification that the building component associated with the product identifier code is or will be installed at the real property unit associated with the unit identifier code;
electronically identify the manufacturer associated with the building component based on the product identifier code;
transmit an electronic notification of the installation at the real property unit to the manufacturer; and
provide the manufacturer with contact information that allows the manufacturer to transmit information to a user associated with the real property unit.

2. The computer-based communications system of claim 1, wherein the information from the manufacturer comprises at least one of: installation instructions, a safety alert, a recall notice, maintenance instructions, a maintenance schedule, a warranty registration, a product offer, a service offer, a coupon, information about replacement parts, a survey, manufacturer contact information, contact information for parts providers, an installation warning notice when an attempt is made to install conflicting or outdated products, and contact information for service providers.

3. The computer-based communications system of claim 1, wherein the user associated with the real property unit is an installer wishing to install the building component at the real property unit and wherein the information for transmitting to the user comprises installation instructions.

4. The computer-based communications system of claim 3, wherein the installations instructions are customized for use at the real property unit.

5. The computer-based communications system of claim 4, wherein the installation instructions are customized based on at least one of: the geographic location of the real property unit, the climate zone of the real property unit, a structure type or size of the real property unit, a skill level associated with the installer, and building components used at the real property unit.

6. The computer-based communications system of claim 1, wherein the user associated with the real property unit is at least one of: an owner of the real property unit, an occupant of the real property unit, a builder of the real property unit, a repairman for repairing the building component, an inspector of the building component.

7. The computer-based communications system of claim 1, wherein the computing system is further configured to:
transmit a request for warranty registration to the manufacturer; and
store information about the warranty.

8. The computer-based communications system of claim 1, wherein the contact information comprises at least one of: a mailing address of the real property unit, a mailing address for the user associated with the real property unit, an email address for the user associated with the real property unit, a legal property description, and a telephone number for the user associated with the real property unit.

9. The computer-based communications system of claim 1, wherein the contact information allows the manufacturer to transmit information intended for the user to the computing system and wherein the computing system makes the information available to the user.

10. The computer-based communications system of claim 9, wherein the computing system is further configured to store the information from the manufacturer for the user associated with the real property unit.

11. The computer-based communications system of claim 1, wherein the contact information allows the manufacturer to transmit information intended for the user directly to the user.

12. A system for collecting and maintaining information about components in a real property unit, the system comprising:
a unit identifier tag that comprises a unit identifier code and that is affixed to a real property unit for uniquely identifying the real property unit;
a product identifier code for identifying a component in the real property unit, wherein the product identifier code is affixed to the component or to packaging associated with the component;
an input device for electronically obtaining the unit identifier from the unit identifier tag and the product identifier; and
a software component configured to receive the unit identifier code and the product identifier code from the input device and to store the unit identifier code and the product identifier code in a record associated with the real property unit.

13. The system of claim 12, wherein the software component is further configured to use the product identifier code to identify a manufacturer of the component and to communicate with the manufacturer.

14. The system of claim 12, wherein at least one of the unit identifier code and the product identifier code is machine-readable.

15. The system of claim 14, wherein the input device reads the machine-readable code using at least one of: bar code technology, radio frequency identification technology, and optical character recognition technology.

16. The system of claim 12, further comprising a computer-implemented user interface that allows a builder associated with the real property unit to access the record associated with the real property unit and to access information in the record about at least one of: one or more workers working at the real property unit, dates and times when the one or more workers work at the real property unit, qualifications of the workers, and verification that installation instructions for the component have been followed.

17. A computer-implemented method for electronically registering a warranty for a building component used in the construction of a real property unit, the computer-implemented method comprising:
receiving, at a computing system, information from an electronic device used during construction of a real property unit, wherein the information includes at least a unique unit identifier for the real property unit and a product identifier for a building component used in the construction of the real property unit;
using the product identifier to identify a manufacturer of the building component;
establishing a computer-implemented contact with the identified manufacturer and providing information about the building component and about the real property unit in order to register a warranty for the building component;
receiving a confirmation of the component's warranty registration; and
storing a record of the warranty registration in the computing system.

18. The computer-implemented method of claim 17, further comprising:
receiving installation information for installing the building component; and
transmitting the installation information to the electronic device.

19. The computer-implemented method of claim 17, further comprising:
providing a web page accessible to an owner of the real property unit, wherein the web page allows the owner to view data stored in the computing system about the real property unit and about the warranty.

20. The computer-implemented method of claim 19, further comprising:
receiving and storing transmitted information from the manufacturer; and
making the information from the manufacturer available to the owner via the web page.

21. The computer-implemented method of claim 20, wherein the information from the manufacturer comprises at least one of: product installation information, product maintenance information, product safety information, product recall information, general product information, product upgrade information, and promotional information.

22. A computer-implemented method for electronically providing current installation instructions for a building component used in the construction of a real property unit, the computer-implemented method comprising:
receiving, at a computing system, information from an electronic device used during construction of a real property unit, wherein the information includes at least a unique unit identifier for the real property unit and a product identifier for a building component used in the construction of the real property unit;
using the product identifier to identify a manufacturer who manufactured the building component; and
establishing a computer-implemented communication with the identified manufacturer and providing information about the building component and about the real property unit in order to receive installation instructions for the building component.

23. The computer-implemented method of claim 22, further comprising:
transmitting to the manufacturer additional information about the real property unit, wherein the additional information comprises at least one of: geographic information, climate zone information, soil information, size of the real property unit, type of the real property unit, information about other components used in the real property unit.
